(19) United States
(12) Patent Application Publication
(10) Pub. No.: US 2011/0302191 A1
(43) Pub. Date: Dec. 8, 2011

(54) System and Method for Locating Business Verifications from Trusted Persons

(76) Inventor: Evgenios Moroz, Kiev (UA)

(21) Appl. No.: 12/794,003

(22) Filed: Jun. 4, 2010

(51) Int. Cl. G06F 17/30

(52) U.S. Cl. 707/769; 707/E17.014

(57) ABSTRACT

Systems and methods for obtaining comments of businesses from trusted persons are disclosed. In an embodiment of the present invention, users participating in the system get comments of businesses from other people they trust by searching the comments previously made by those others. Trust connections may be established between pairs of users, before a search is made. Comments made by the system users are stored in a database and are searched based upon search requests made by the users. Both the stored comments and search requests each comprise “tag lists” of words describing some good or service. Businesses are selected to appear in search results by matching words of the comments to a search request, as well as other possible factors, and may be sorted by the number of matching comments that each business has received. Various methods may be used to further filter the results.

### FIELD OF THE INVENTION

The present invention relates generally to online business reviews. More specifically, the invention relates to methods for locating comments about businesses, called “verifications,” from trusted persons.

### BACKGROUND OF THE INVENTION

People have been reviewing businesses both formally and informally for many years. For example, a potential customer might seek advice from friends whose advice the customer trusts before patronizing a business, such as a store or restaurant. Over time, there has also grown to be an entire business segment dedicated to providing reviews that collect the opinions of many people, as well as more professional, and presumably unbiased, reviews.

For example, there are reviews of national scope, such as Consumer Reports reviews of business chains such as stores, hotels and restaurants, which may include both their staffers' allegedly unbiased reviews as well as collected readers' reviews. There are also nationwide efforts to find the best businesses of a particular type in various locations, such as guidebooks or articles that purport to list the best hotels or restaurants across, for example, the United States, typically based upon the authors' opinions and analyses.

At the local level, local media outlets such as newspapers, radio and television stations may provide reviews of local businesses. In between the national and purely local efforts, such reviews as the Zagat Restaurant Surveys seek to rate business across the country, using collected user reviews, but publish their results as local guides to specific cities.

In recent years the enormous growth of the internet has provided almost instant access to many of these reviews and others. Consumer Reports, Zagat, some guidebook publishers and many local media outlets all have websites at which their content may be viewed, either for free or upon some payment or subscription fee. Some “gateway” or search sites such as Yahoo and MSN have “local” areas for different geographic areas that contain reviews of businesses that may be searched by type and location.

In addition to these, a number of other websites have also been created specifically for the purpose of providing people with access to business reviews and/or statistics about customers' opinions. These include, for example, CitySearch, Yelp and Urbanspoon; some of these sites have related smart-phone applications that allow users to access their content over a data network without the use of an internet browser.

While these sites and applications have made it easier for potential customers, i.e. users, to locate comments from others about either a specific business or a group of businesses (e.g., steak restaurants in a particular city), the reviews are generally “free form,” i.e., a reviewer may enter a description using any words the reviewer chooses. Thus, the user may be forced to read a large number of reviews to find specific desired information, such as reviews of steaks at a restaurant having many other dishes on the menu. Further, they still rely on collecting reviews from either staffers or any member of the public who wishes to submit a review. Thus, a user is still forced to rely upon reviews of people who are overwhelmingly likely to be strangers, and whose references and abilities, and thus the reliability of their opinions, is completely unknown.

Social networking has also recently become very popular as a way of allowing people to connect and communicate with each other. Sites such as Facebook and MySpace allow users to post information about their interests and activities for others to read, and to read the information that others have posted. Twitter allows users to broadcast their thoughts via “tweets” to any persons who have chosen to “follow” them, i.e., to receive their tweets. Thus, users are able to provide information to a large number of people by posting only once, rather than having to communicate directly with each other person with whom it is desired to share information

However, while social networking sites allow for the sharing of large amounts of information, and individuals may post “reviews” for all of their friends and contacts to see, these reviews are not believed to be organized in any meaningful way. One seeking to find recommendations from a friend, for example, must visit the friend's web page and is not able to simultaneously see recommendations from a group of connections or other trusted people.

Thus, it would be desirable to have the ability to search for a particular type of business and see recommendations from only people trusted by the person doing the search or other specific connections such as experts or co-workers, rather than to have to sift through recommendations from strangers, or visit a separate web page for each such connection.

### SUMMARY OF THE INVENTION

Systems and methods for obtaining comments of businesses from trusted persons are disclosed. In some embodiments of the present invention, users participating in the system get comments of businesses from other people they trust by searching the comments previously made by those others. Trust connections may be established between pairs of users, before a search is made. Comments made by the system users are stored in a database and are searched based upon search requests made by the users. Both the stored comments and search requests each comprise “tag lists” of words describing some good or service. Businesses are selected to appear in search results by matching words of the comments to a search request, as well as other possible factors, and may be sorted by the number of matching comments that each business has received. Various methods may be used to further filter the results.

In one embodiment, a computer-implemented method of locating comments for businesses comprises: receiving a plurality of comments, each comment referring to a specific business and comprising a tag list of words; forwarding each comment to the business to which it refers; for each sent comment, receiving an indication of whether the business has activated the comment for inclusion in a database stored in a memory; entering the activated comments into the database; receiving a search request comprising a tag list; and searching the database with a processor to locate the businesses having words in their comments that match any of the words in the search request.

In another embodiment, a computer-readable medium has embodied thereon a program, the program being executable by a processor to perform a method comprising the steps of: receiving a plurality of comments, each comment referring to a specific business and comprising a tag list of words; forwarding each comment to the business to which it refers; for each sent comment, receiving an indication of whether the business has activated the comment for inclusion in a database stored in a memory; entering the activated comments into the database; receiving a search request comprising a tag list; and searching the database with a processor to locate the businesses having words in their comments that match any of the words in the search request.

In still another embodiment, a system for locating comments for businesses, comprises: input/output means for communicating with users and businesses; a memory for storing a database; and a processor configured to: receive a plurality of comments, each comment referring to a specific business and comprising a tag list of words; forward each comment to the business to which it refers; for each sent comment, receive an indication of whether the business has activated the comment for inclusion in a database stored in a memory; store the activated comments in the database; receive a search request comprising a tag list; and search the database with a processor to locate the businesses having words in their comments that match any of the words in the search request.

### BRIEF DESCRIPTION OF THE DRAWINGS

FIGS. 1 through 6 are exemplary screen shots that may be displayed to a user in one embodiment of the system of the present invention.

FIG. 7 shows a simplified flow chart of a method according to one embodiment of the invention.

### DETAILED DESCRIPTION OF THE INVENTION

The present application describes a method and system for obtaining comments regarding businesses, referred to as “verifications,” from known and trusted persons. In an embodiment of the present invention, users participating in the system get verifications of businesses from other people they trust by searching the verifications previously made by those others. Connections may be listed, or trust relationships established between pairs of users, before a search is made. Verifications made by the system users are stored in a database and are searched based upon search requests made by the users.

In general, both the stored verifications and search requests each comprise “tag lists” of words describing some good or service. Businesses are selected to appear in search results by matching words of the verifications to a search request, as well as other possible factors, and may be sorted by the number of matching verifications that each business has received. Various methods may be used to further filter the results.

### Registration and Relationships

Users who wish to participate and get access to verifications must first register and create an account with a User ID, which may be, for example, a real name, a screen name or an email address. Once registered, a user may then indicate other registered users who are “connections,” which may include persons known to the user that were previously registered in the system, or who the user has invited to join the system, as well as “experts” or co-workers.

While in some embodiments a user may select any other user as a connection, it is expected that in general a user will list as connections persons whose opinions the user believes to be reliable or valuable. In some embodiments of the present invention, a “trust relationship” may be created between two users only when each user independently indicates that the other is a trusted connection. As discussed herein, the user's connections and/or trust relationships may be used to sort or limit search results.

A registered user may have a home page within the system that is accessed through a web browser and permits a user to perform various functions described herein. For example, the user's home page may be the place where the user indicates those other persons in the system that are the user's connections, or those with which the user wishes to have trust relationships. The user's home page may typically also be one place where the user enters verifications of businesses as below, and may contain the user's complete history of such verifications. Alternatively, a mobile application, such as on a smart phone, may provide such functionality.

If desired, the system may permit a user to enter other information on the user's home page, such as the user's full name, location, email address, picture, biographical information, etc., and may permit other users to locate the user's web page and see some or all of such information. Other functions may also be available on the user's home page as described herein.

In order to limit the number of trust relationships and maximize their value, in some embodiments of the present invention no notice is provided by the system that one person has selected another as a trusted person until both parties have independently done so and the trust relationship is established. This may be distinguished from, for example, Facebook, where a person sends a “friend” request to another person to be accepted or denied.

However, as a practical matter, as with some other social networking systems it is expected that a user will contact friends and ask them to join the system. If friends choose to join, the user may then contact them by means outside the system, for example by telephone, either to tell them that the user has selected them as connections, or to indicate that the user wishes to establish a trust relationship with them and ask them to similarly select the user as a trusted connection to complete the relationship.

To get the full benefit of verifications from those connections that a user most values, it is expected that users will wish to limit their trust relationships to a relatively few number of people whose opinions are considered to be of value. (One exception to this may be the case of “experts,” discussed herein.) While a user of a system of the present invention may list hundreds or thousands of people as connections, and could in theory establish trust relationships with them, the tastes of such a large number of people are not likely to be well known to the user. Further, many of those people may not be located in the same geographic area and thus be unable to offer relevant verifications.

In response to a search, a user with such a large number of connections is thus likely to receive a large number of verifications from those connections which are of little or no value. An embodiment requiring two-way independent selection of trust relationships makes enormous numbers of those relationships unlikely, and helps prevent the resulting dilution of search results that are actually meaningful for the user.

Businesses that wish to participate also register with the system. A registered business may also have a web page which may be accessed by users through the system's interface via a web browser. The business web page may contain information similar to that often found on a typical web page on the internet, such as the location and hours of the business, contact information, photos, and descriptions of the business offerings such as menus, product lists, etc., as well as other information and functionality as described in more detail herein.

### Reference Checks

When a user visits a business that is registered and wishes to comment on that business, the user identifies the business and the date of a transaction with the business, and creates a “reference check” i.e., a tag list of words that describe the user's experience. Identification of the business and entry of the reference check will generally be done by the user online via an interface on a web browser. In various embodiments, the system interface may allow the user to enter the reference check either through the user's home page or the business web page within the system as described herein.

Alternatively, the user may provide a reference check on paper (most easily on a pre-printed form) and deliver it to the business either in person or by mail, although it is believed that most users will be unlikely to provide reference checks in this manner. In such a case, however, the reference check may be entered into the system by the business receiving it, and is otherwise treated as a reference check entered online by a user, as described below.

In various embodiments, the user may be limited to a fixed number of words in each tag list, and/or may also be limited to a fixed number of tag lists per transaction. It is believed that limiting the number of words to, for example, four or five will result in a more efficient system, as most products, services or transactions may be adequately summed up in a list of such length, and that limiting the number of lists per business to about five will similarly allow for a sufficiently detailed description of a given transaction. Allowing more words per list, and/or more lists, may be expected to unnecessarily expand the database and require greater storage capacity and search times without providing significantly better results, and may instead decrease the relevancy of results.

In some embodiments, the user may be provided with suggested words and/or lists to use with respect to a given transaction. Suggestions may even be made by a business itself; for example, a restaurant may wish to publicize a signature dish or house specialty by providing pre-defined reference checks in the hope that diners will select them, which may result in a higher rating for the restaurant as described herein. Other businesses may similarly wish to publicize particular products or services or other qualities. In such a case, the user might go to the business' web page and find a suggested list of reference checks, either listed on the page or in a pull-down menu. The user may then select one of the pre-defined reference checks if desired. However, in such cases a user may also be allowed to enter any words of his or her choice, as long as the number of words or lists entered does not exceed the number permitted.

Thus, a user who eats at a seafood restaurant and wishes to review it will typically provide the name of the restaurant, or select it from a list or menu, the date of the visit, and then a tag list, again either by selecting one or more pre-selected words or by typing a list of words. For example, a user might enter the tag list “awesome salmon steak” to describe the user's dining experience. (Although the restaurant example is used generally herein, the present invention may be applied to any type of business, including those providing both products and/or services.)

If the user wishes to do so, and the system is programmed to allow it, the user may enter additional reference checks, i.e., tag lists, for the same or a related transaction; for example, the user may wish to describe other dishes, a wine or wine list, the service the user received, etc. In some embodiments, the user is also permitted to identify, and then similarly enter reference check tag lists to describe, one or more particular employees, such as a maitre d′ or waiter. In such embodiments, the user may be limited to a certain number of words per list, and a certain number of lists to describe employees, in the same way that such limitations may apply to the business itself.

The reference check is then typically sent to the business identified, which may review the reference check. The business determines whether it wishes to “activate” the reference check, i.e., to have the reference check included in the database of public reviews and thus be searchable and viewable by users. If the business declines to activate the reference check, then the business may retain the user's comments, but those comments will not be searchable and viewable by other users.

The business may decide that it does not want to activate the reference check and have it be publicly available for a variety of reasons. For example, the user may be inadvertently referring to the wrong establishment, or have said something that is factually incorrect. In some embodiments, the business may decline to activate the reference check for any reason, although presumably in such cases only good reference checks will be published, as businesses will not be expected to wish to have negative comments made public.

On the other hand, if the business activates the reference check, the reference check is added to the database so that it may be located in various ways as described herein. To add the reference check to the database, the tag list entered by the user is first broken into individual words, and each word is checked to see if it is already in the database. If a word is not already present, it is added to the database.

The database contains an indication of all of the words associated with a business, i.e., the words that have been used in reference checks with respect to the business, and the number of times that each word has been so used. Thus, once the words of a new reference check tag list are confirmed to be in the database, the system updates the database to indicate that the newly entered tag list is associated with the business.

If the business is not yet associated with one or more of the words in the new tag list, such as words that have been newly added to the database, an indication that the business is associated with those words is entered and becomes part of the system database. In the case of words for which an association with the business is already present, the number of instances of such association for each word is updated.

In addition, an indication is entered into the database that the entire reference check is associated with both the user's User ID and the business so that it may be located in various ways as described herein. This may done either by creating an entry for the reference check as a whole, or by the use of pointers to the individual words that have been stored in the database as above. Methods of implementing either of these alternatives will be apparent to those of skill in the art.

For example, this will allow the web page of a business to display all of the reference checks that the business has chosen to activate. If a user has a particular business in mind, the user may be able to locate the web page for the business and see reference checks for the business without doing a tag list search as described herein. This may also allow a business to see the User IDs of those users that have submitted reference checks for the business, and how many times they have visited the business, so that a business may track those customers who visit most frequently or write the most favorable reference checks.

Similarly, a user's web page may be able to display all of the reference checks written by the user, whether activated or not. In various embodiments the list of reference checks on the user's web page may be visible to only the user, or to those having trust relationships with the user, or to any user of the system.

In some embodiments, the reference checks will remain in the database for only a limited time. This insures that only current reviews are searchable, and prevents old and possibly outdated reviews from being provided in response to a search request from a user. If desired, the time may depend upon the type of business. For example, businesses where the quality of a product or service is more likely to vary significantly over short periods of time might have a two week limit, while other businesses expected to have less variation with time may have a longer limit. Alternatively, all businesses may be subjected to a single time limit.

### Searching

When a user wishes to locate a business, the user enters a search request which, like a reference check, is comprised of a tag list of one or more words. As with a reference check, the search request may be limited to a particular number of words. The user may enter a broad request of a single word, or a more detailed request, up to the maximum number of words permitted. In various embodiments the search request may be entered from the user's home page or from another search page.

Thus, a user looking for restaurants might make a broad request such as “salmon” or “seafood” to locate restaurants that serve a desired specific food or general cuisine. Alternatively, the user might enter a more specific request for “classic French” or “Asian fusion” cuisine, or even a request for a particular dish such as “osso buco” or “Cajun blackened redfish.”

Again as with a reference check, the search request is broken into its individual words. The system receives the search request and finds the closest matches to it by searching the database for each of the individual words in the search request, and identifying the businesses that have been associated with those words. As it is presumed that a user will not be as interested in the reference checks made by people unknown to the user, in some embodiments, the user will see results only from connections that the user has listed, whether or not trust relationships have been established with those users.

The resulting list of businesses may be presented in a variety of ways. For example, in some embodiments the order of businesses in the returned search results may be based upon the total number of associations each business has to the words in the search request. In other embodiments, the order may also be influenced by the number of different words in the search request with which a business is associated, so that a business associated with two of the search words may rank higher than a business associated with only one search word. Priority may also be given to businesses in either the same geographic area as the user or in an area designated by the user. Such sorting techniques are well known in the art.

It can be seen that, in general, the more detailed a search request the user makes, the more specific the search results may be since there may be more associations of certain businesses to a longer search request. It will also be seen that it will be advantageous to a business to have as many reference checks as possible, since this will result in a greater number of associations with the search words, and more users giving reference checks to the business means that more connections in the system will see the business in their search results. This should thus cause the business to be listed at or near the top of the results for more searches.

In some embodiments, the user may be able to see all of the search results from reference checks done by all users of the system. This may be particularly useful in cases in which none of a user's connections have done a reference check on a particular business. Such a business in the designated geographic area that matches the search request may thus still be listed in the search results, although it may generally be listed lower than businesses that do have reference checks from the user's connections.

The results are then provided to the user that made the search request. If the default is to include all businesses that have received reference checks from any connections of the user, whether there is a trust relationship or not, or if businesses without reference checks from such connections have been included as above, various embodiments of the present invention allow for the user to sort the search results in a variety of ways.

Along with a list of the business matching the search words that have reference checks from the user's connections, in some embodiments the system will also provide a list of the most popular words used in connection with the words of the search request. By selecting one or more of these additional words, the user may refine the search results and obtain a subset of the original results. In one embodiment, the system will re-sort the search results according to the number of associations of each business to the additional words selected. Alternatively, the number of associations to the additional words may be added to the number of associations of each business to the words in the original search request.

The search results may also be further limited to those businesses having reference checks from people with whom the user has a trust relationship, from “experts” as described herein, or from co-workers. A user may choose to limit the results to those businesses having verifications from all of the user's trust relationships, or to only those businesses having reference checks from one or more specific connections.

In addition, the business web page in a system according to the present invention may typically allow users to see those reference checks regarding the business that the business has activated. If desired, the business web page may also allow the entry of reference checks, in addition to such entry on the users' web pages as above. Thus, in some embodiments, a user may enter the system through the online interface, locate a business by, for example, either entering its name or selecting it from a menu system, and then enter a reference check for the business. The reference check might be entered by the user typing in the words of a tag list, or alternatively by selecting a tag list suggested by the business from a menu.

In some embodiments the business web page will also display all of the activated reference checks provided by users regarding the business. This allows a user who is interested in a particular business to easily see verifications for that business without having to do a search by entering a search request. Also, as with search results, the user may be permitted to either see all of the verifications for the business, or to find those verifications made by only the user's trusted connections.

### Pictures

In some embodiments, pictures may be attached to reference checks and displayed by the business to which they refer. For example, a user at a bar or restaurant wishing to enter a reference check regarding a particular wine may be allowed to take a picture of the bottle and submit it along with the reference check tag list. The picture may then appear on the user's web page where all of the user's reference checks are displayed, next to the appropriate reference check, for as long as desired.

The business (the bar or restaurant) will receive the reference check and determines whether to activate it as above. The business also receives the picture and is able to determine whether to approve it or not. In some embodiments, the reference check and picture are approved, i.e., activated, together, while in others the business may be able to activate the reference check but decline to approve the picture.

If the reference check is activated and the picture approved, as above the reference check will appear on the business' web page and in appropriate search results, but now with the picture displayed next to the reference check in either or both cases. If desired, to avoid clutter, display may be limited to a certain number of pictures, for example 3 to 5, on the business' web page, or with the business' name in search results. Alternatively, only a certain number of pictures may be attached to a specific reference check (particularly in cases in which the business has pre-defined reference checks that are selected by users), with only the specified number of the most recently approved pictures being displayed with each reference check.

### Employees of Businesses

Some embodiments permit a user to review one or more employees of a business in the same way. The user indicates the business at which the employee works, the employee's name, and the date of a transaction, and then enters a reference check for the employee, i.e., a tag list describing the employee and/or the transaction. In one embodiment, the reference check for an employee must be attached to the reference check for the business, i.e., a reference check may not be for an employee only. The reference check is entered into the database in a similar fashion to a reference check on the business.

As with the reference checks on businesses, it is thought that a certain number of words, for example four or five, will be sufficient for a user to describe an employee or transaction. Similarly, just as a relatively small number of reference checks, such as five, should suffice to allow a user to review a visit to a business, it seems unlikely that a user will interact with more than a few employees on a visit, and so the number of reference checks that a user may submit for employees for a particular visit may also be limited to five or another desired, but still relatively small, number.

Reference checks on employees may be used in various ways. In some embodiments, employees and their reference checks may be listed on the web page of the business at which they work. This will allow users who visit the business' web page to see the employees who work there and their verifications, and, in appropriate cases, to select a specific employee with whom they wish to conduct their particular transaction at the business in question.

In addition, the reference check tag lists of employees may also be used to respond to a search request. In this case, matches between the tag list words in the search request and employee reference check tag list words may be counted for the purpose of determining which businesses match the search request, and the order in which those businesses are presented to the user making the search. In various embodiments, the matching words in the employee reference checks may count as much as matching words in business reference checks. In other embodiments, the matching words in the business reference checks are counted more heavily, so that the results are presented first in order of matches to the business reference checks as described above, and matches in employee reference checks are used only to break ties in the number of matching words in the business reference checks.

Employee reference checks may also be used internally by businesses. For example, a business will typically be able to see all of the reference checks for each of its employees, and thus able to check an employee's performance or progress, or to compare employees. In some embodiments, an employee may choose to “share” a reference check with another employee who helped serve the user in some way but did not receive an independent reference check. For example, a waiter could share a reference check with the maitre d′ or with a busboy who helped refill a customer's drinks, etc.

In addition, if the employee reference checks appear on the business web page, each employee will also be able to see all of the reference checks that the employee has received. This may, for example, allow employees to demonstrate to the employer that they are doing a good job, or improving in some way, and may be of use in salary or other negotiations. In some embodiments, an employee's reference checks will remain associated with the employee in the database even if the employee changes employers and works for another business. In this way the employee is able to create a form of resume from his or her accumulated reference checks.

### Experts

If desired, in some embodiments the system may allow for “experts,” i.e., reviewers considered in some way to have special knowledge or expertise in their respective fields. While any user may seek to become an expert, it is considered desirable that there be some qualification required rather than merely letting a user declare that he or she is an expert. This may be accomplished in various ways. In one embodiment, the first user indicates that he or she wishes to become an expert in a particular field, and submits reference checks in that field. If a sufficient number of reference checks from the user are activated by businesses in that field then the user is deemed to be an expert.

The number of activated reference checks required may be as many or few as desired. In order to encourage users to become experts, for example, the number may be set at a low level, for example three. Thus, one wishing to become an expert for restaurants would have to have three restaurants activate reference checks from the user after the user has indicated the desire to be an expert. On the other hand, if it is considered too easy for users to become experts, the number may be set higher. It may be required that the restaurants have different names and/or locations so that they are separate and unaffiliated.

Thus, a user wishing to be an expert in the area of restaurants would first register that desire in the system in some fashion. In one embodiment, the user's home page may contain a button that the user can click labeled “become an expert.” After clicking this button, the user would either type in the field in which he or she desires to be an expert, i.e., “restaurants,” or alternatively may select the field from a drop-down menu of available options. Such a drop-down menu would, for example, prevent confusion if a user tries to enter “food” or “eating” rather than “restaurants.”

A user wishing to be an expert in restaurants then submits reference checks for a number of restaurants. In some embodiments, reference checks that are to be used to qualify the user as an expert may be distinguished from normal reference checks written by the user, for example, by being labeled as “unverified expert checks.” Normal reference checks would not be so labeled, and would be treated in the normal fashion as described herein.

If a reference check intended to count toward qualifying the user as an expert is so labeled, it is delivered to the appropriate restaurant as described above, along with an indication that the user has indicated a desire to be an expert in the field of restaurants, such as the label described above, and that the attached reference check is intended for that purpose. In some embodiments, the restaurant is able to conduct some type of screening of the user at its option before deciding whether to activate the reference check. The restaurant then decides whether to activate the reference check as above; if enough restaurants activate such “expert checks,” then the user is considered to be an expert in the field. Other methods of determining whether a user is qualified to be an expert may also be used.

Once a person is considered an expert in a field, various abilities and functions may be made available which are not available to non-expert users. For example, an expert may be permitted to have a web page that is visible to all users, and to post reviews on that web page in the form of articles, rather than just reference check tag lists. The web page may be limited to a certain number of recent reviews, or alternatively may show all of the expert's reviews, and may contain other information such as biographical or contact information, the period of time the expert has been so designated, the number and/or names of the businesses that the expert has reviewed, etc.

In some embodiments, web pages of experts may be found by any user, either as a group by the use of a filter or search for “experts,” or by searching for a specific expert's web page by name. Businesses reviewed by the expert may also choose to make such reviews available on their web pages.

In some embodiments, a user may “subscribe to,” or follow, one or more experts. This may result, for example, in the experts that a user subscribes to being listed first when the user uses the group filter or search for experts above. In some embodiments, the results may be further sorted by the number of subscribers each expert has, and/or by how many times the user has visited businesses recommended by each expert. However, if desired, users may be permitted to view experts' web pages without subscribing. Where subscription is allowed, the web page of an expert with subscribers may additionally contain information about the number of such subscribers.

In a system with experts, when a user receives the results of a search, another way in which the results may be further sorted is by indicating a preference for verifications and/or reviews from experts. This may be accomplished, for example, by the use of a click button on the interface labeled “experts.” In one embodiment, this causes any verifications from experts in the system to be placed at the top of the search results.

In other embodiments, preference will be given first to those experts subscribed to by the user, so that these will appear first and then be followed by any other experts to whom the user does not subscribe. The order of the experts to whom the user subscribes may be further sorted, for example by the number of subscribers that each expert has, and/or by the activity of their subscribers at the businesses recommended by each expert.

If desired, users' web pages may indicate the experts to whom they subscribe. If this is the case, and a user visiting a business gives his User ID to the business, then the business will be able to see whether the user subscribes to one or more experts, and whether those experts have provided reviews of the business. This may cause a business to seek ways to provide incentives to those experts whose reviews result in the greatest number of visits to the business. Some such incentives are discussed herein.

In some embodiments, there may be a “direct feedback” feature which allows an expert's subscribers to communicate their experiences or concerns about a business they visited as a result of a review by the expert. An expert's integrity may be based at least in part upon whether the expert relays such feedback to the business or requests that the business address any issues where appropriate.

### Gifts

In some embodiments of the present invention, business may use gifts to entice customers to visit. One way of doing this is to include an indication on the business web page that the business will provide something to the user for visiting, for example in the form of a click button that says “get a gift.” A user who finds the business in the results of a search and goes to its web page will see the gift button. For example, a restaurant may offer a discount, a free appetizer or dessert, or a free coffee to new diners.

If the user clicks the button, a code or passkey appears that the user may take to the business and present there to receive the described gift. The user may be required to enter a User ID to obtain the code, and/or to present a User ID at the business. This requirement can be used to track what gifts the user has received and to prevent users from collecting more gifts than are being offered. For example, the business may choose to limit users to a single gift, or a certain number over a period of time, say once a month. Alternatively, a business may choose to give gifts of increasing value to repeat customers.

In other alternatives, users may register for frequent customer awards of some type, and receive points for each visit that over time may be collected and then redeemed for awards, in a similar fashion to frequent flier awards and the like. In such a case, points may be posted to the user's User ID in the system, and the user then able to track the progress toward such awards on the user's web page.

In still other embodiments, users may see the gifts that their connections, or those with which they have trust relationships, have received. This may enable them to request the same gifts when they visit businesses which have been recommended by those connections. Which connections see the gifts may depend upon what the gifts are, with a higher percentage of a user's connections seeing larger gifts than smaller ones.

### Commercialization

The present invention may be more directly commercialized in a number of ways. For example, an expert may enter into a contract with a business under which the expert is paid when the business gets customers who subscribe to the expert, as these may be presumed to be a result of the expert's verification. Different amounts may be set for new customers than for returning customers. (Of course, the payments may be zero in some cases.) The contract might also require that the business provide certain gifts or points to the master's subscribers for each visit. The operator of the system may collect some percentage of the compensation under such contracts for the tracking of which users visit which businesses, and to which experts they subscribe.

Other types of commercialization may also be employed. Businesses may pay to have advertisements shown in connection with search results that are related to them. Businesses may also pay a fee for the activation of reference checks about them, or may pay a fee to the system for permission to offer gifts through the business web page on the system. They may also pay for the privilege of having the connections of users see the gifts that have been given to those users as described above, and/or offering customized gifts to those connections in special advertising blocks on users' web pages. Those payments may also be tiered by how many of each user's connections see a user's gifts. Other ways of commercializing various elements of the present invention will be obvious to those of skill in the art.

### Examples

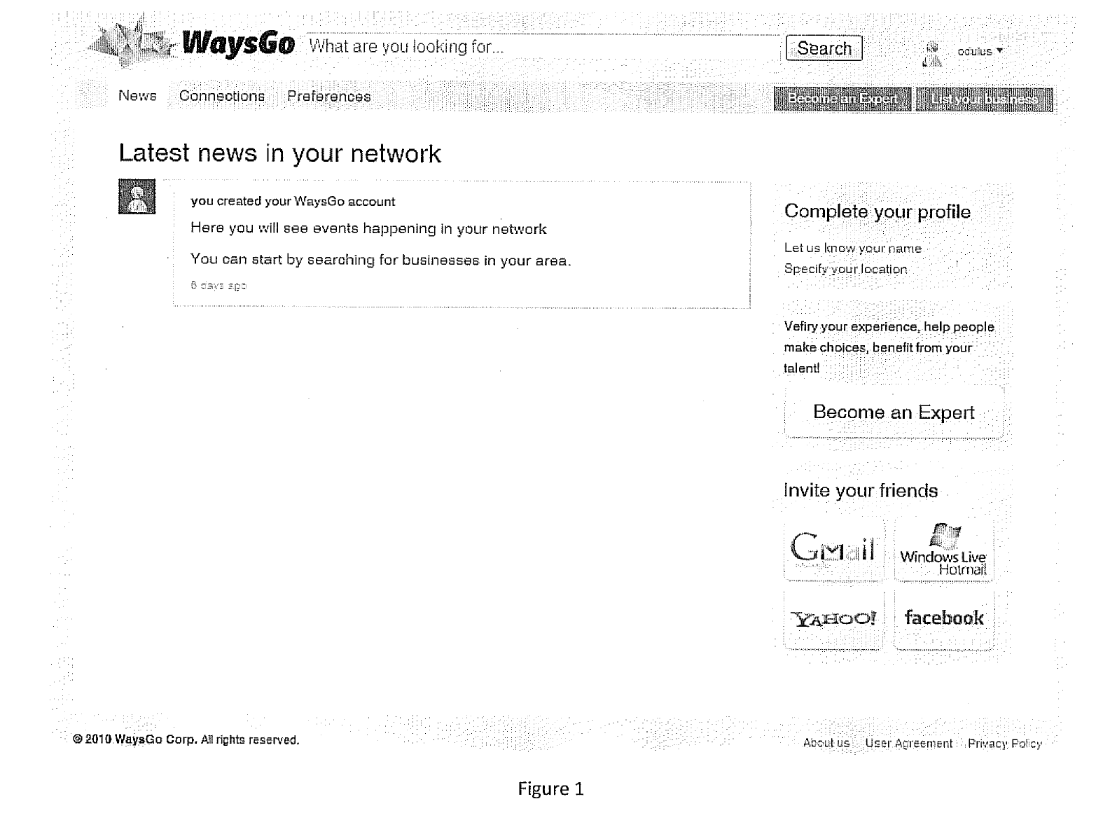

FIGS. 1 through 6 are representative screen shots that may be presented to a user in a browser window in one embodiment of the present invention.

FIG. 1 is a screen that may be presented to a user who, after registering, logs in to the system. The page contains a search bar, in which the user may type a search request, i.e., a taglist. It also lists “Latest news in your network,” which can include any events relevant to the user as defined by the system, allows the user to invite friends to join from various email systems and from Facebook, and to jump to various other pages within the system.

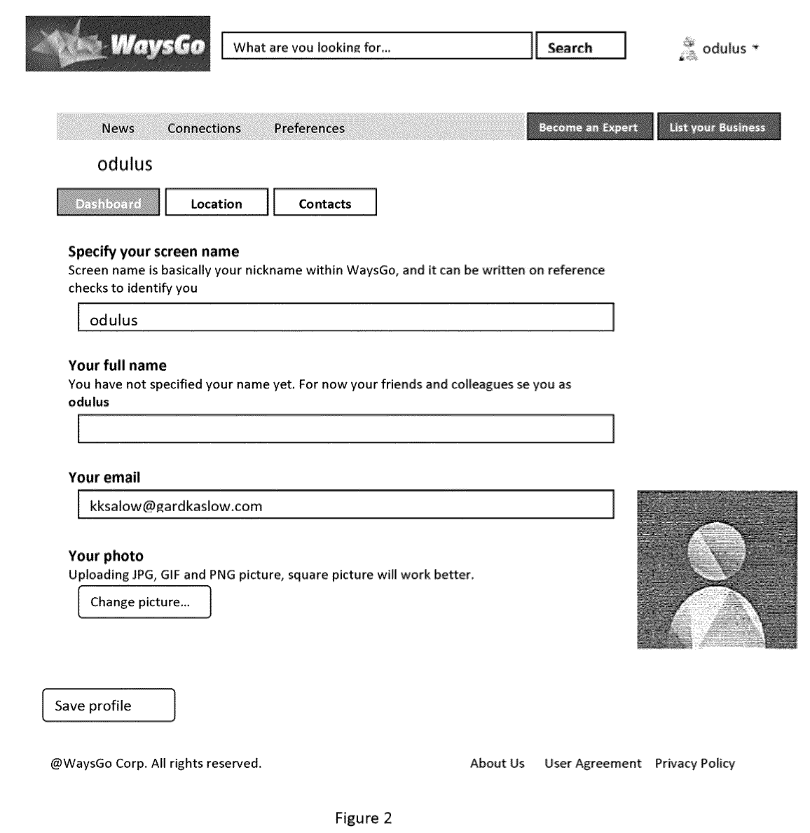

FIG. 2 is a screen that allows the user to specify a screen name, a real name, and an email address, as well as to upload a photograph of the user. In various embodiments, some or all of these may be viewable by other users. Buttons on this page also allow the user to go to a page where the user may enter his or her geographic location, or another geographic location in which the user wishes to search, and again to jump to other various other pages within the system interface.

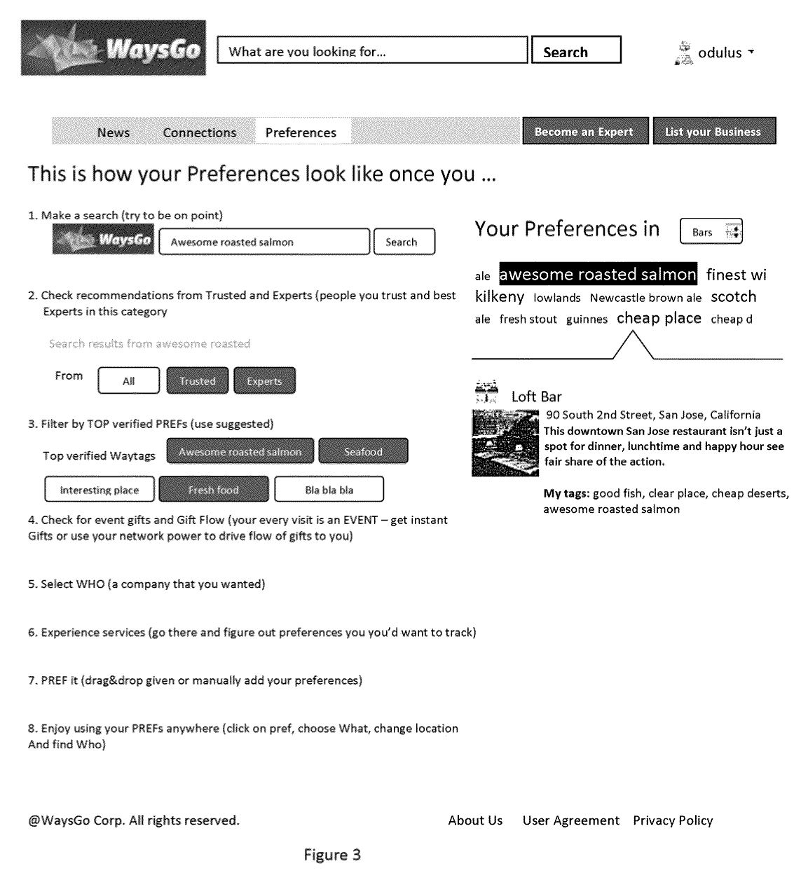

FIG. 3 is a screen that is intended to contain a history of the user's reference checks and to group them by category and time. The user may locate a previously-given reference check by the name of the business, seek businesses with similar tags in a different geographical location, see what gifts the user has received, or perform other searching and/or sorting as the system permits. Again a search bar is available, as well as buttons that allow the user to jump to other pages in the system.

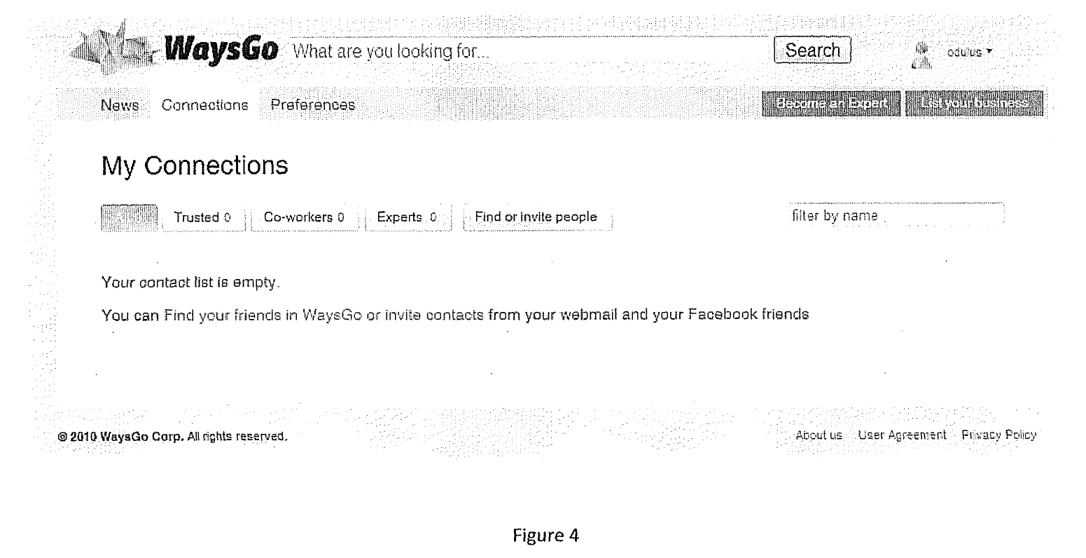

FIG. 4 is a screen that shows the user what connections the user has entered into the system. As illustrated, this page may list all connections of all types, or may be limited to those with which the user has trust relationships, experts, or, if the user is an employee of a business, co-workers. The user may also filter byname, or find or invite others. Again a search bar is present, and buttons to jump to other system pages.

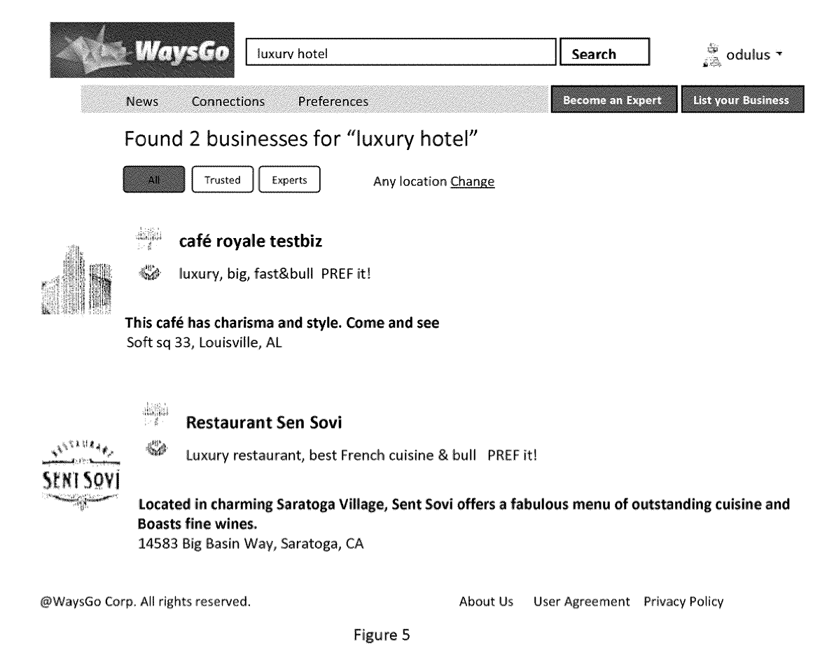

FIG. 5 is a screen containing a sample of results that may be returned for a search for “luxury hotel.” In this case, the database does not contain any hotels, and thus the results list two restaurants having reference checks containing the word “luxury.” The reference checks for these restaurants are shown, so it may be seen that one has a tag list “luxury, big, fast,” while the other has the tag list “luxury restaurant, best French cuisine.” The default is set to show results in any location, with a place to click to change the default location. The default is also set to show all results, with buttons to limit the results to businesses with references from those in trust relationships, or to experts. Again a search bar and buttons to jump to other pages are present.

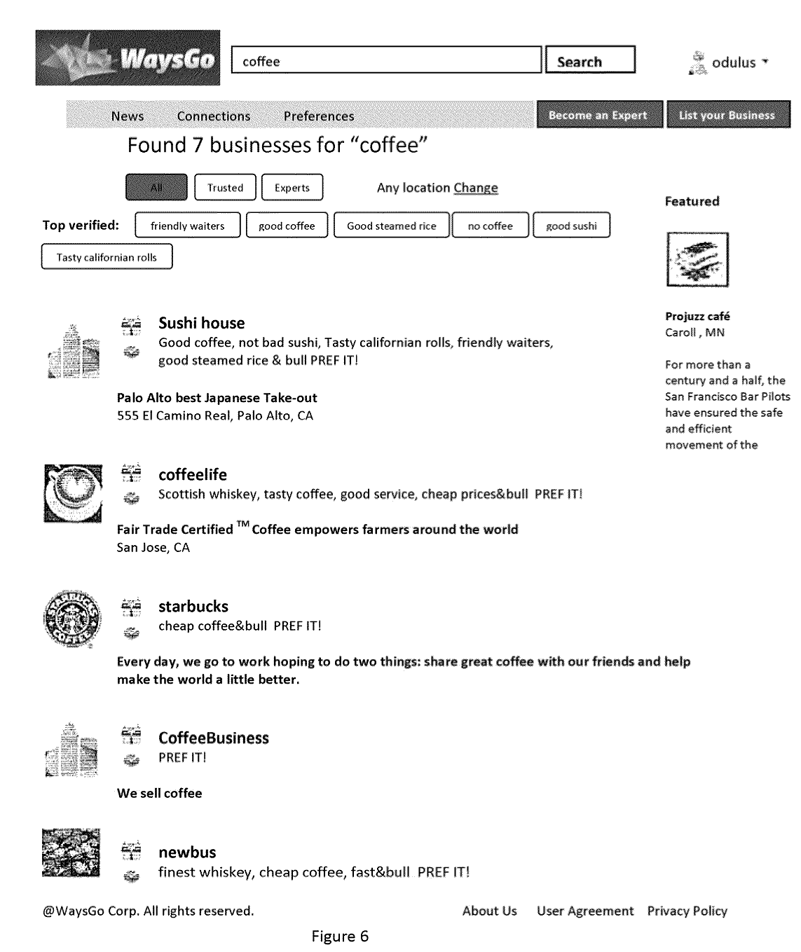

FIG. 6 shows a portion of another screen containing a sample of results for a search for “coffee.” It will be seen that such a broad request may include both coffee shops such as Starbucks and others, as well as restaurants or other businesses for which reference checks include the word “coffee.” As above, the highest listed businesses will be those with the largest number of verifications from users containing the word “coffee.” Again the user has the option to limit the results to those having verifications from those in trust relationships with the user, or experts, or to limit the geographic location. In addition, here it can be seen that the user is presented with an assortment of other taglists (which may be single words or multiple words) which are associated with the businesses in the search results, and which the user can select to refine the results.

In this case, because the search returned, for example, the Sushi House, the additional tag lists include entries such as “good steamed rice,” “not bad sushi,” and “tasty California rolls,” which may not be useful in refining search results for coffee. However, depending upon the initial search and what reference checks have been submitted for businesses on the search result list, other tag lists related to the businesses on the list may be more useful, such as “good coffee” or “friendly waiters.” The page also contains an advertisement for a “featured” business that relates to the search request, for which an advertising fee may be charged. Finally, the page again contains a search bar and buttons that allow the user to jump to other pages.

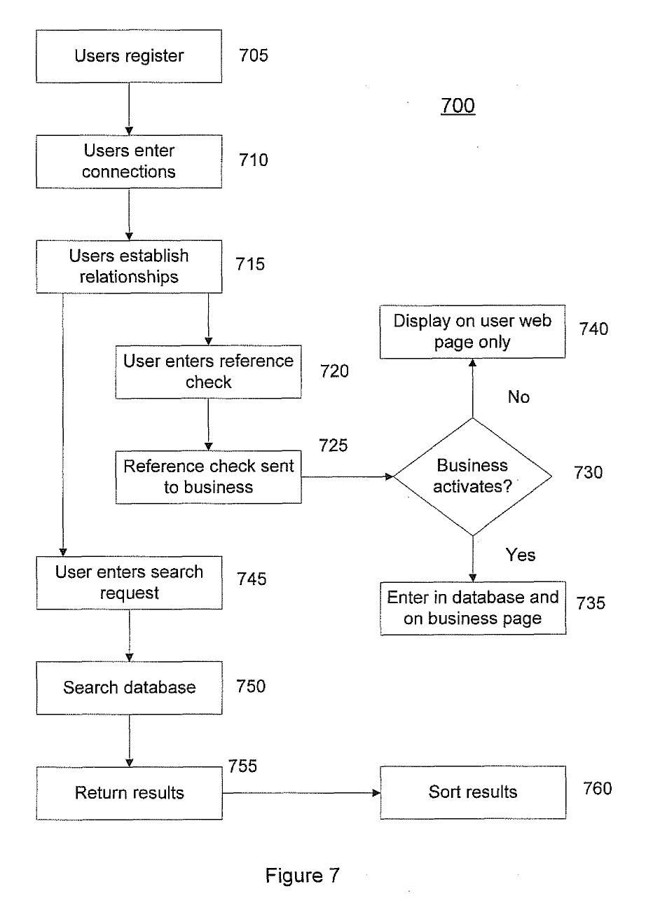

FIG. 7 shows a simplified flow chart of a method 700 according to one embodiment of the invention. Further detail of, and alternatives to, the steps shown in FIG. 7 are explained herein. At step 705, users register with the system, and then enter connections at step 710. They then establish relationships with some or all of those connections as described herein, which may be trust relationships, subscriptions to experts, etc., at step 715.

A user then enters a reference check at step 720, and the reference check is sent to the business identified in the reference check at step 725. At step 730, the business decides whether to activate the reference check. If the business activates the reference check, the reference check is added to the database and placed on the business' web page at step 735. If the business does not activate the reference check, then the reference check is only made visible on the web page of the user that entered it at step 740.

At step 745, a user enters a search request, and the database is searched for businesses with reference checks matching the search request as described herein at step 750. The results are returned to the user at step 755, and may be sorted in a variety of ways at step 760, for example based upon the user's relationships, other words, etc., as described herein. The steps of method 700 may be modified or supplemented in a variety of ways, as also described herein.

The invention has been explained above with reference to several embodiments. Other embodiments will be apparent to those skilled in the art in light of this disclosure. The present invention may readily be implemented using configurations other than those described in the embodiments above, or in conjunction with systems other than the embodiments described above. For example, tag lists of different length may be used, the described web pages may be implemented in different ways, alternative types of menus may be used, etc. Other variations within the scope of the present invention will appear to those of skill in the art.

It should also be appreciated that the present invention can be implemented in numerous ways, including as a computer-implemented process, an apparatus, or a system. The methods described herein may be implemented by program instructions for instructing a processor, server or system to perform such methods, and such instructions recorded on a computer readable storage medium such as a hard disk drive, floppy disk, optical disc such as a compact disc (CD) or digital versatile disc (DVD), flash memory, etc., or a computer network wherein the program instructions are sent over optical or electronic communication links. Information regarding users, trust relationships, business verifications and other data may be stored in a non-volatile memory, such as a hard disk, flash memory, etc., that is accessible by a processor, server or computer system. The present invention may be used with existing databases and website systems and interfaces, or may be implemented as an independent application with its own database and computer or server. It should be noted that the order of the steps of the methods described herein may be altered and still be within the scope of the invention.

These and other variations upon the embodiments are intended to be covered by the present invention, which is limited only by the appended claims.

What is claimed is:

1. A computer-implemented method of locating comments for businesses, comprising:
receiving a plurality of comments, each comment referring to a specific business and comprising a tag list of words;
forwarding each comment to the business to which it refers;
for each sent comment, receiving an indication of whether the business has activated the comment for inclusion in a database stored in a memory;
entering the activated comments into the database;
receiving a search request comprising a tag list; and
searching the database with a processor to locate the businesses having words in their comments that match any of the words in the search request.

2. The computer-implemented method of claim 1 further comprising ranking the businesses located by the search by the number of times the words in the search request have been used in all of the comments referring to each business.

3. The computer-implemented method of claim 1 further comprising:
registering a plurality of users who provide the plurality of comments;
receiving an indication from a first user indicating that other users are connections of the first user;
wherein the search request is received from the first user; and
listing the businesses located by the search which have comments from the connections of the first user.

4. The computer-implemented method of claim 1 further comprising:
registering a plurality of users who provide the plurality of comments;
defining one or more trust relationships between pair of users;
wherein the search request is received from a first user having one or more trust relationships with other users; and
listing the businesses located by the search which have comments from users in trust relationships with the first user.

5. The computer-implemented method of claim 1 further comprising:
registering a plurality of users who provide the plurality of comments;
receiving an indication from a first user that the first user wishes to be considered to have special expertise in a particular type of business;
determining that the first user should be deemed to have such special expertise;
receiving an indication from a second user indicating that the second user wishes to see comments from the first user;
wherein the search request is received from the second user; and
listing the businesses located by the search which have comments from the first user.

6. The computer-implemented method of claim 5 wherein determining that the first user should be deemed to have special expertise further comprises having a predetermined number of businesses activate comments from the first user.

7. The computer-implemented method of claim 1 wherein searching the database further comprises returning a list of the words most commonly used in the comments of the located businesses.

8. The computer-implemented method of claim 7 further comprising:
registering a plurality of users who provide the plurality of comments;
wherein the search request is received from a first user;
presenting the first user with the list of words commonly used in the comments of the located businesses;
receiving a selection from the first user of one or more of the commonly used words; and
listing the businesses located by the search which also have comments using the commonly used words selected by the first user.

9. The computer-implemented method of claim 1, wherein each activated comment indicates a date of a transaction with the business to which it refers, and further comprising removing the comment from the database after a predefined period of time.

10. The computer-implemented method of claim 1 wherein one or more of the received plurality of comments further comprises a tag list that has been predefined by the business to which the comment refers.

11. A system for locating comments for businesses, comprising:
input/output means for communicating with users and businesses;
a memory for storing a database; and
a processor configured to:
receive a plurality of comments, each comment referring to a specific business and comprising a tag list of words;
forward each comment to the business to which it refers;
for each sent comment, receive an indication of whether the business has activated the comment for inclusion in a database stored in a memory
store the activated comments in the database;
receive a search request comprising a tag list; and
search the database with a processor to locate the businesses having words in their comments that match any of the words in the search request.

12. The system of claim 11 wherein the processor is further configured to rank the businesses located by the search by the number of times the words in the search request have been used in all of the comments referring to each business.

13. The system of claim 11 wherein the processor is further configured to:
register a plurality of users who provide the plurality of comments;
receive an indication from a first user indicating that other users are connections of the first user;
wherein the search request is received from the first user; and
list the businesses located by the search which have comments from the connections of the first user.

14. The system of claim 11 wherein the processor is further configured to:
register a plurality of users who provide the plurality of comments;
define one or more trust relationships between pair of users;
wherein the search request is received from a first user having one or more trust relationships with other users; and
list the businesses located by the search which have comments from users in trust relationships with the first user.

15. The system of claim 11 wherein the processor is further configured to:
register a plurality of users who provide the plurality of comments;
receive an indication from a first user that the first user wishes to be considered to have special expertise in a particular type of business;
determine that the first user should be deemed to have such special expertise;
receive an indication from a second user indicating that the second user wishes to see comments from the first user;
wherein the search request is received from the second user; and
list the businesses located by the search which have comments from the first user.

16. The system of claim 15 wherein the processor is further configured to determine that the first user should be deemed to have special expertise if a predetermined number of businesses activate comments from the first user.

17. The system of claim 11 wherein the processor is further configured to return a list of the words most commonly used in the comments of the located businesses.

18. The system of claim 17 wherein the processor is further configured to:
register a plurality of users who provide the plurality of comments;
wherein the search request is received from a first user;
present the first user with the list of words commonly used in the comments of the located businesses;
receive a selection from the first user of one or more of the commonly used words; and
list the businesses located by the search which also have comments using the commonly used words selected by the first user.

19. The system of claim 11, wherein each activated comment indicates a date of a transaction with the business to which it refers, and wherein the processor is further configured to remove the comment from the database after a predefined period of time.

20. The system of claim 11 wherein one or more of the received plurality of comments further comprises a tag list that has been predefined by the business to which the comment refers.

21. A computer-readable medium having embodied thereon a program, the program being executable by a processor to perform a method comprising the steps of:
receiving a plurality of comments, each comment referring to a specific business and comprising a tag list of words;
forwarding each comment to the business to which it refers;
for each sent comment, receiving an indication of whether the business has activated the comment for inclusion in a database stored in a memory;
entering the activated comments into the database;
receiving a search request comprising a tag list; and
searching the database with a processor to locate the businesses having words in their comments that match any of the words in the search request.
